(19) United States
(12) Patent Application Publication
(10) Pub. No.: US 2005/0220655 A1
(43) Pub. Date: Oct. 6, 2005

(54) Rolling piston and gas leakage preventing apparatus for rotary compressor having the same

(75) Inventor: Seoung-Yeon Cho, Daejeon (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/097,219

(22) Filed: Apr. 4, 2005

(30) Foreign Application Priority Data
Apr. 6, 2004 (KR) 23506/2004

(51) Int. Cl. F03C 2/00

(52) U.S. Cl. 418/139

(57) ABSTRACT

A gas leakage preventing apparatus for a rotary compressor comprises: a cylinder having a cylindrical inner space therein; a rotating shaft having an eccentric portion therein which makes a circular motion in the inner space of the cylinder; a rolling piston inserted into the eccentric portion of the rotating shaft and being linearly contact with an inner wall of the inner space of the cylinder; a vane linear-movably inserted into a vane slot which is formed in the cylinder and dividing the cylinder inner space together with the rolling piston; and fixing units provided in the rolling piston and vane, for restraining a rotary motion of the rolling piston. As a result, it is possible to maximize gas compression efficiency by minimizing leakage of high pressure gas

### BACKGROUND OF THE INVENTION

1. Field of the Invention

The present invention relates to a compressor, and more particularly, to a rolling piston and a gas leakage preventing apparatus for a rotary compressor having the same capable of minimizing leakage of high pressure gas through a gap between a rolling piston and a vane.

2. Description of the Conventional Art

In general, compressors convert electrical energy into kinetic energy and compress a refrigerant gas by the kinetic energy. The compressors, as a main component configuring a refrigeration cycle system, include various types such as a rotary compressor, a scroll compressor, a reciprocal compressor and the like. Such compressors are used in refrigerators, air-conditioners, showcase coolers and the like.

FIGS. 1 and 2 are longitudinal sectional view and cross-sectional view showing the rotary compressor.

As shown in the drawings, the rotary compressor includes: a casing 10; a driving motor 20 mounted in the casing 10, for generating a rotating force; a cylinder 30 having an inner space P therein and mounted in the casing 10 at a certain interval with the driving motor 20; a rotating shaft 40 having an eccentric portion 41 therein positioned in the inner space P of the cylinder 30, and rotated by being coupled to the driving motor 20; a rolling piston 50 inserted into the eccentric portion 41 of the rotating shaft 40; a vane 60 linear-movably inserted into the cylinder 30 and being contact with the rolling piston 50, for partitioning the inner space P of the cylinder 30; a main bearing 70 and a sub bearing 80 coupled to both sides of the cylinder 30, respectively, for closing the inner space P of the cylinder 30 and supporting the rotating shaft 40.

A suction pipe 11 is coupled to one side of the casing 10, and a discharge pipe 12 for discharging a compressed gas is coupled to the other side of the casing 10.

The driving motor 20 includes a stator 21 fixed in the casing 10 and a rotator 22 rotatably inserted into the stator 21.

The cylinder 30 includes: a body portion 31 formed in a predetermined shape and fixed into the casing 10; an inner space P penetratingly formed to have a certain inner diameter in the body portion 31; a vane slot 32 formed in the body portion 31 to be communicated with the inner space P; a discharge port 33 formed at an edge of the inner space P to be positioned at a side of the inner space P; and an suction hole 34 penetrating through the body portion 31 to be communicated with the inner space P. The discharge pipe 12 is communicated with the suction hole 34.

The rotating shaft 40 includes a shaft portion 42 having predetermined outer diameter and length, and the eccentric portion 41 formed at a side of the shaft portion 42 with predetermined outer diameter and thickness. The center of the eccentric portion 41 is positioned to be eccentric relative to the center of the shaft portion 42 with a certain distance.

The shaft portion 42 of the rotating shaft 40 is press-fitted in the rotator 22, and the eccentric portion 41 thereof is positioned in the inner space P of the cylinder 30. The inner space P of the cylinder 30 has a circular through hole shape with a certain inner diameter, and the center thereof is positioned on the same axis as the center of the shaft portion 42 of the rotating shaft 40.

The rolling piston 50 is formed in a circular ring shape with predetermined thickness and length, and rotatably inserted into the eccentric portion 41 of the rotating shaft 40. At this time, a certain side of an outer circumferential surface of the rolling piston 50 is linearly contact with an inner circumferential surface of the inner space P of the cylinder 30.

The vane 60 has a square plate shape therein with a predetermined thickness. The vane 60 is inserted into the vane slot 32 of the cylinder 30, and a certain side thereof is linearly contact with the outer circumferential surface of the rolling piston 50. The vane 60 is elastically supported by a vane spring S.

The main bearing 70 has a discharge hole 71 communicated with the discharge port 32 formed therein, and a discharge valve assembly 90 for opening and closing the discharge hole 71 is positioned on the main bearing 70.

Unexplained reference symbol 93 is a muffler, 94 is a coupling bolt and 95 is a balance weight.

An operation of such conventional rotary compressor will be explained as follows.

First, when power is applied to the compressor, the driving motor 20 is driven and thus a rotating force is generated therefrom. The rotating force generated from the driving motor 20 is transferred to the rotating shaft 40 to allow it to be rotated. According to the rotation of the rotating shaft 40, the eccentric portion 41 of the rotating shaft 40 performs a circular motion in the cylinder inner space P in a state of being eccentric relative to the center of the cylinder inner space P.

According to the circular motion of the eccentric portion 41 of the rotating shaft 40 in the cylinder inner space P, the rolling piston 50 inserted into the eccentric portion 41 of the rotating shaft 40 performs a circular motion by taking a centerline of the shaft portion 42 of the rotating shaft 40 as an axis, in a state that it is linearly contact with the inner circumferential surface of the cylinder inner space P and with the vane 60. At this time, as the rolling piston 50 performs the circular motion, the vane 60 performs a reciprocating motion in the vane slot 32 formed in the cylinder 30 in a state of being linearly contact with the outer circumferential surface of the rolling piston 50.

By the circular motion of the rolling piston in the state that the cylinder inner space P and the vane 60 are linearly contact with the outer circumferential surface of the rolling piston 50, respectively, the cylinder inner space P is converted into a suction space P1 and a compression space P2, and volumes of the suction space P1 and the compression space P2 are changed. Depending on the change of the volumes of the suction space P1 and the compression space P2, a gas is sucked through the suction pipe 11 and compressed so as to be discharged through the discharge port 33 and the discharge hole 71.

The gas which has been compressed and discharged in/from the cylinder inner space P is discharged to the outside through the discharge pipe 12 passing through the casing 10.

However, as described above, in the conventional rotary compressor, when the vane 60 which is linearly contact with the outer circumferential surface of the rolling piston 50 divides the cylinder inner space P into the suction space P1 in a state of low pressure and the compression space P2 in a state of high pressure, a pressure leakage from a contact surface between the rolling piston 50 and the vane 60 may be caused by a pressure difference between the suction space P1 and the compression space P2. As a result, compression efficiency can be decreased.

Explaining this in more detail, as the eccentric portion 41 of the rotating shaft 40 performs the circular motion, the rolling piston 50 makes the circular motion together with the eccentric portion 41. Accordingly, the rolling piston 50 and the vane 60 linearly contact with the rolling piston 50 make a relative motion according to the circular motion of the rolling piston 50. Moreover, the circular motion of the rolling piston 50 allows the vane 60 to make a reciprocating motion in the vane slot 32 of the cylinder 30.

In such state, as can be seen in FIG. 3, when the pressure of the compression space P2 increases, the vane 60 inclines toward the suction space P1 by the pressure of the compression space P2. According to this, a fine gap is formed between the vane 60 and the rolling piston 50 so as to cause a leakage of high pressure gas. When the vane 50 is pressed, it inclines by a coupling tolerance between the vane 60 and the vane slot 32 so that the fine gap between the vane 60 and the rolling piston 50 is generated. In addition, the fine gap between the vane 60 and the rolling piston 50 is generated by abrasion which may be caused by a friction contact between the vane 60 and the rolling piston 50.

### SUMMARY OF THE INVENTION

Therefore, an object of the present invention is to provide a rolling piston and a gas leakage preventing apparatus for a rotary compressor having the same capable of minimizing a gas leakage when compressing the gas.

To achieve these and other advantages and in accordance with the purpose of the present invention, as embodied and broadly described herein, there is provided a gas leakage preventing apparatus for a rotary compressor including: a cylinder having a cylindrical inner space therein; a rotating shaft having an eccentric portion therein which makes a circular motion in the inner space of the cylinder; a rolling piston inserted into the eccentric portion of the rotating shaft and being linearly contact with an inner wall of the inner space of the cylinder; a vane linear-movably inserted into a vane slot which is formed in the cylinder and dividing the cylinder inner space together with the rolling piston; and fixing units provided in the rolling piston and vane, for restraining a rotary motion of the rolling piston.

Another embodiment of the present invention is to provide a rolling piston including: a cylindrical body portion formed in a ring shape with predetermined length and thickness and rotatably coupled to the eccentric portion of the rotating shaft, and a fixing groove formed at an outer circumferential surface of the cylindrical body portion in a direction of its length and into which one side of the vane is inserted.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a longitudinal sectional view showing a conventional rotary compressor;

FIG. 2 is a cross-sectional view showing the conventional rotary compressor;

FIG. 3 is a sectional view showing a partially enlarged portion of the rotary compressor shown in FIG. 2;

FIG. 4 is a longitudinal sectional view showing a rotary compressor provided with an embodiment of a gas leakage preventing apparatus in accordance with the present invention;

FIG. 5 is a cross-sectional view showing the rotary compressor provided with the embodiment of the gas leakage preventing apparatus in accordance with the present invention;

FIG. 6 is a perspective view showing a rolling piston configuring the gas leakage preventing apparatus for the rotary compressor in accordance with the present invention;

FIG. 7 is a sectional view showing another embodiment of the gas leakage preventing apparatus for the rotary compressor in accordance with the present invention;

FIG. 8 is a sectional view showing an operation state of the rotary compressor provided with an embodiment of the gas leakage preventing apparatus in accordance with the present invention; and

FIG. 9 is a sectional view showing an operation state of the gas leakage preventing apparatus for the rotary compressor in accordance with the present invention.

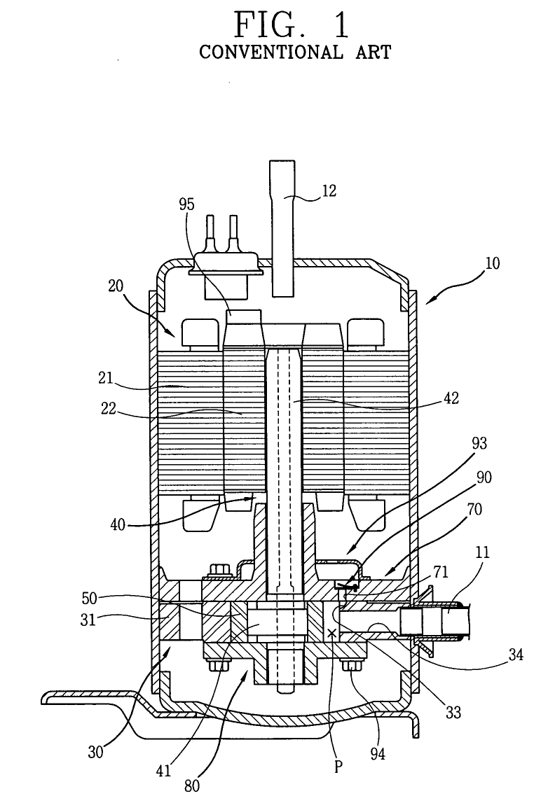

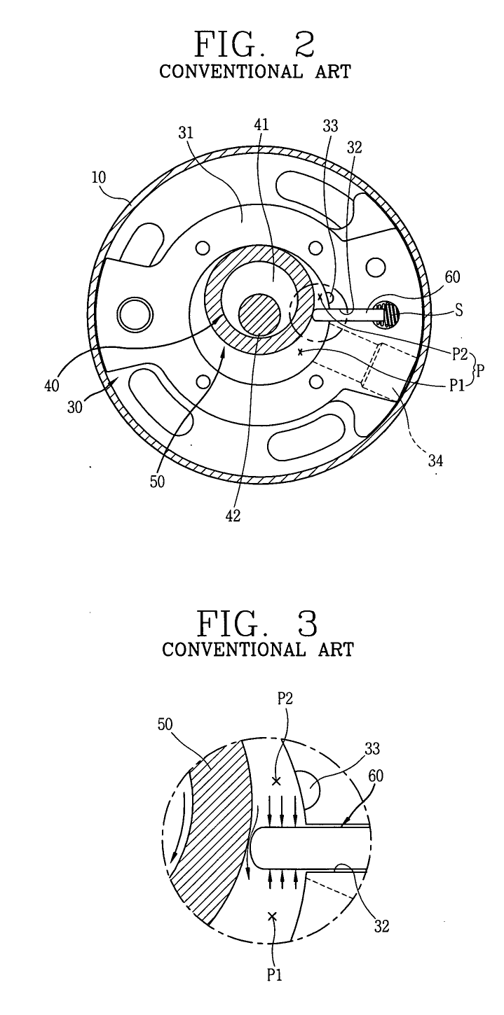

### DETAILED DESCRIPTION OF THE PREFERRED EMBODIMENTS

Reference will now be made in detail to the preferred embodiments of the present invention, examples of which are illustrated in the accompanying drawings.

Hereinafter, a rolling piston and a gas leakage preventing apparatus having the same according to the present invention will be explained in detail with reference to the accompanying drawings.

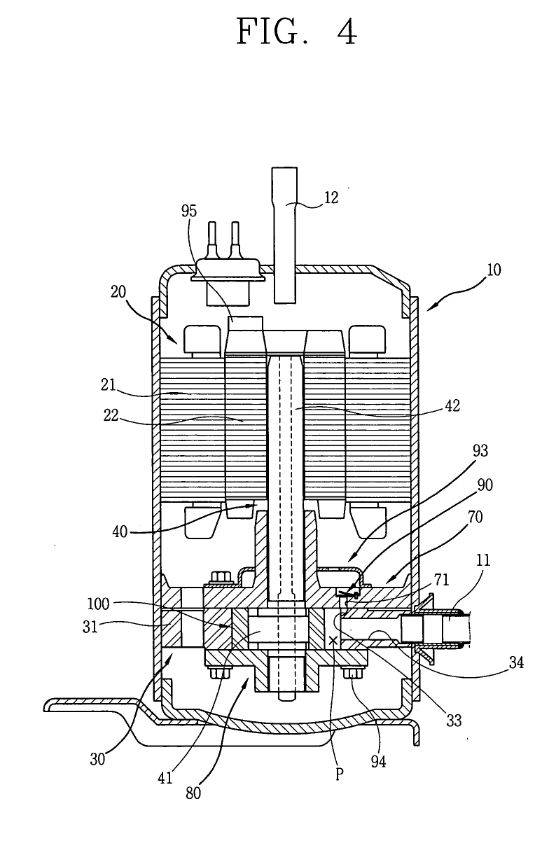

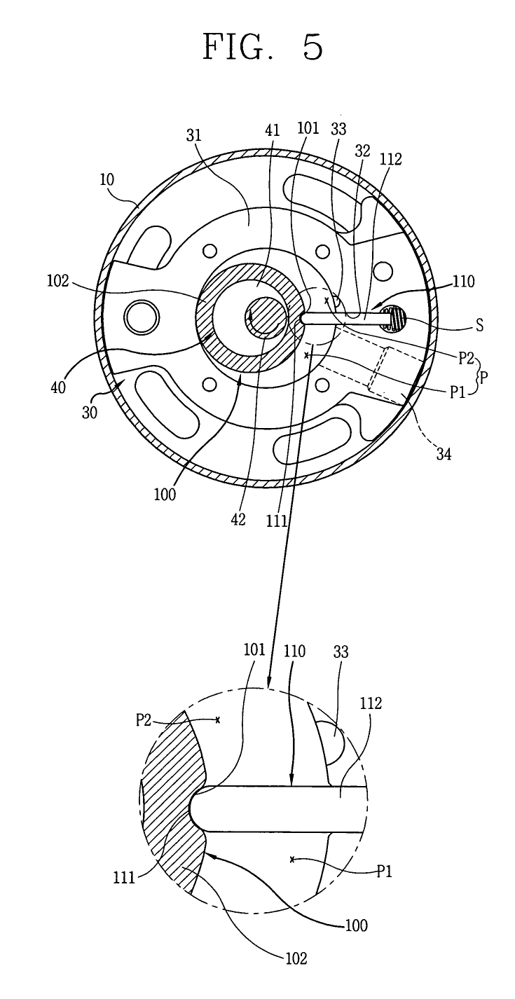

FIGS. 4 and 5 are longitudinal and cross sectional views, respectively, showing a rotary compressor provided with an embodiment of a rolling piston and a gas leakage preventing apparatus according to the present invention. The same part as the conventional art has the same symbol.

Referring to FIGS. 4 and 5, first, the rotary compressor includes: a casing 10; a driving motor 20 mounted in the casing 10, for generating a rotating force; a cylinder 30 having an inner space P therein and mounted in the casing 10 at a certain interval with the driving motor 20; a rotating shaft 40 having an eccentric portion 41 therein positioned in the inner space P of the cylinder 30, and rotated by being coupled to the driving motor 20; a rolling piston 100 inserted into the eccentric portion 41 of the rotating shaft 40; a vane 110 linear-movably inserted into the cylinder 30 and being contact with the rolling piston 100, for partitioning the inner space P of the cylinder 30; a main bearing 70 and a sub bearing 80 coupled to both sides of the cylinder 30, respectively, for closing the inner space P of the cylinder 30 and supporting the rotating shaft 40.

A suction pipe 11 is coupled to a certain side of the casing 10, and a discharge pipe 12 for discharging a gas therethrough is coupled to the other side of the casing 10.

The driving motor 20, the cylinder 30 and the rotating shaft 40 have the same structures as the conventional art, so that explanations therefor are omitted.

Fixing units for restraining a rotary motion of the rolling piston 100 are installed at the rolling piston 100 and the vane 110.

The fixing units include a fixing groove 101 formed at an outer circumferential surface of the rolling piston 100, and a contact fixing portion 111 of the vane 110 inserted into the fixing groove 101 of the rolling piston 100.

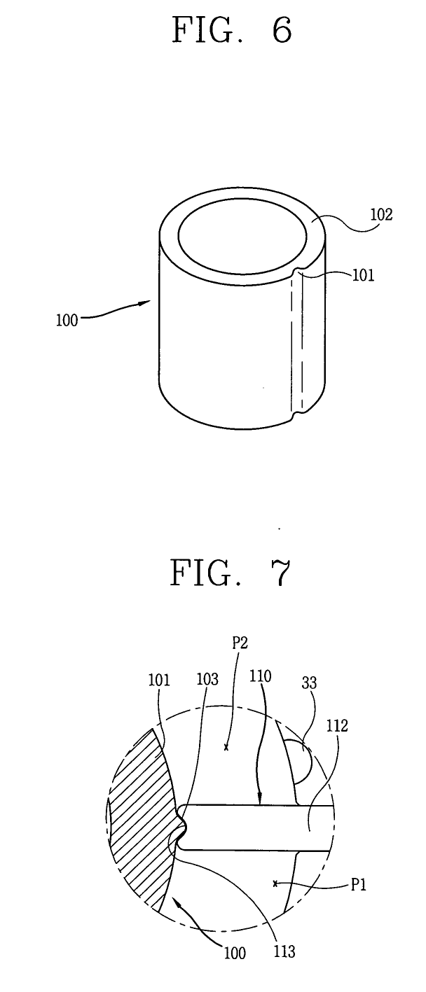

The rolling piston 100, as shown in FIG. 6, includes a cylindrical body portion 102 formed in a ring shape with predetermined length and thickness, and the fixing groove 101 formed at the outer circumferential surface of the cylindrical body portion 102. An inner diameter of the cylindrical body portion 102 corresponds to an outer diameter of the eccentric portion 41 of the rotating shaft. The rolling piston 100 is rotatably inserted into the eccentric portion 41 of the rotating shaft, and one side of the outer circumferential surface thereof is linearly contact with an inner wall of the cylinder inner space P.

The vane 110 includes a square plate portion 112 with a predetermined thickness, and the contact fixing portion 111 formed at one side of the plate portion 112 and inserted into the fixing groove 101 of the rolling piston 100.

The vane 110 is reciprocatably inserted into a vane slot 32 of the cylinder, and its contact fixing portion 111 is inserted into the fixing groove 101 of the rolling piston 100. The vane 110 is elastically supported by a vane spring S inserted into the vane slot 32 of the cylinder. The fixing groove 101 of the rolling piston 100 is formed in a direction of length of the cylindrical body portion 102. Its sectional shape is a hemi-cycle.

The contact fixing portion 111 of the vane 110 is formed in a curved shape.

In accordance with another embodiment, as shown in FIG. 7, the fixing units include a protrusion portion 103 protruded from an outer circumferential surface of the rolling piston 100, and an insertion groove 113 formed at one end of the vane 110 to allow the protrusion portion 103 of the rolling piston 100 to be inserted thereinto.

The protrusion portion 103 of the rolling piston 100 is formed in a direction of length of the rolling piston 100, and the outer surface of the protrusion portion 103 is formed in a curved surface.

The sectional shape of the insertion groove 113 of the vane 110 is a hemi-cycle.

A discharge hole 71 communicated with the discharge port 33 of the cylinder is formed in the main bearing 70, and a discharge valve assembly 90 for opening and closing the discharge hole 71 is installed on the main bearing 70.

Unexplained reference symbol 93 is a muffler, 94 is a coupling bolt, and 95 is a balance weight.

Hereinafter, an operation effect of a rolling piston and a gas leakage preventing apparatus for a rotary compressor having the rolling piston will be explained as follows.

First, as aforementioned for the operation of the rotary compressor, a rotating force of the driving motor 20 is transferred to the rotating shaft 40 to be rotated thereby. According to the rotation of the rotating shaft 40, the eccentric portion 41 of the rotating shaft 40 makes a circular motion in the cylinder inner space P in a state of being eccentric relative to the center of the cylinder inner space P.

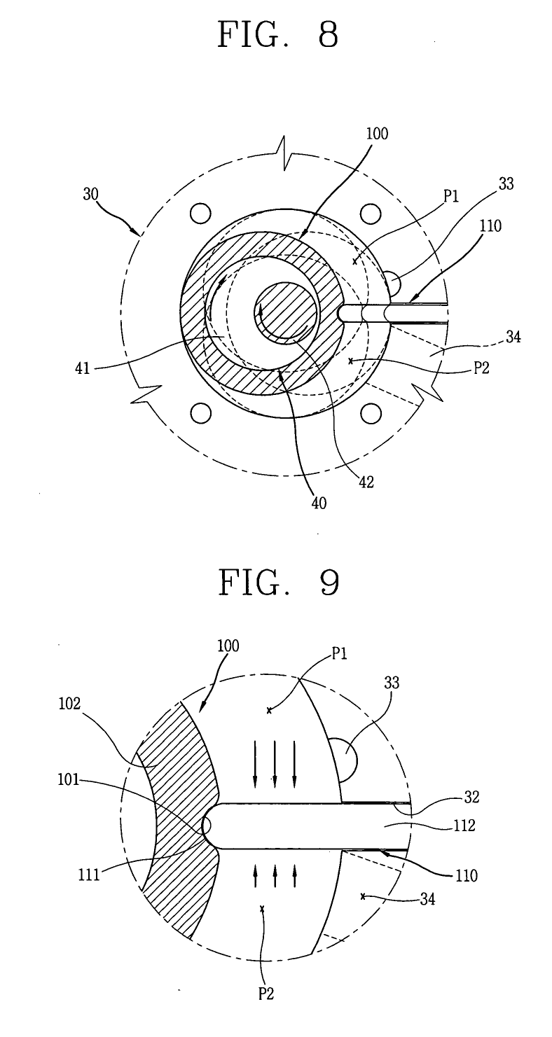

As the eccentric portion 41 of the rotating shaft 40, as shown in FIG. 8, makes the circular motion in the cylinder inner space P, the rolling piston 100 inserted into the eccentric portion 41 of the rotating shaft 40 is linearly contact with the inner wall of the cylinder inner space P so as to convert the cylinder inner space P into a suction space P1 and a compression space P2 and also to change volumes of the suction space P1 and the compression space P2. At this time, the rolling piston 100 also makes the circular motion according to the circular motion of the eccentric portion 41 of the rotating shaft 40. However, the rolling piston 100 itself doesn't make a rotary motion because it is restrained by the fixing units. Therefore, according to the circular motion of the eccentric portion 41 of the rotating shaft 40, a sliding occurs between the outer circumferential surface of the eccentric portion 41 and the inner circumferential surface of the rolling piston 100, but it does not occur between the outer circumferential surface of the rolling piston 100 and the vane 110.

Furthermore, as the circular motion of the eccentric portion 41 of the rotating shaft, the vane 110, which is contact with and fixed to the rolling piston 100 by the fixing units, makes a reciprocating motion in the vane slot 32 of the cylinder. At this time, the vane 110 is elastically supported by the vane spring S.

According to the change of volumes of the suction space P1 and the compression space P2 of the cylinder, on the other hand, a gas is sucked through the suction pipe 11 and compressed so as to be discharged outwardly through the discharge port 33 and the discharge hole 71.

The gas compressed and discharged in/from the cylinder inner space P is discharged outwardly through the discharge pipe 12 passing through the casing 10.

As described above, because the rolling piston 100 is not rotated by the fixing units but makes the circular motion, a friction contact does not occur between the vane 110 and the rolling piston 100. As a result, abrasion can be prevented from occurring between the vane 110 and the rolling piston 100. As can be seen in FIG. 9, because the rolling piston 100 is fixed to the vane 110 by the fixing units, the vane 110 can be prevented from inclining toward the suction space P1 by a pressure difference between the compression space P2 and the suction space P1 which are divided by the vane 110.

On the other side, when the fixing units include the fixing groove 101 of the rolling piston 100 and the contact fixing portion 111 of the vane 110 inserted into the fixing groove 101, because a curved surface of the fixing groove 101 and the curved surface of the contact fixing portion 111 are contact therewith, a sealing area increases so as to enable minimization of leakage of a high pressure gas in the compression space P2 toward the suction space P1.

Furthermore, when the fixing units include the protrusion portion 103 of the rolling piston 100 and the insertion groove 113 of the vane 110, as explained above, the sealing area increases so as to enable minimization of leakage of a high pressure gas in the compression space P2 toward the suction space P1 in a state of low pressure.

As aforementioned, by a rolling piston and a gas leakage preventing apparatus for a rotary compressor having the rolling piston according to the present invention, it is possible to prevent an inclination of a vane which is caused by a pressure difference between a compression space and a suction space in a state of a low pressure of the cylinder, and also possible to minimize an occurrence of a fine gap between the rolling piston and the vane by restraining abrasion occurred between the vane and the rolling piston, which results in minimizing the leakage of high pressure gas. As a result, it is possible to increase compression efficiency of the rotary compressor.

In addition, the leakage of the high pressure gas can be far more minimized by increasing a sealing area, thereby further increasing the compression efficiency.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

1. A gas leakage preventing apparatus for a rotary compressor comprising:
a cylinder having a cylindrical inner space therein;
a rotating shaft having an eccentric portion therein which makes a circular motion in the inner space of the cylinder;
a rolling piston inserted into the eccentric portion of the rotating shaft and being linearly contact with an inner wall of the inner space of the cylinder;
a vane linear-movably inserted into a vane slot which is formed in the cylinder and dividing the cylinder inner space together with the rolling piston; and
fixing units provided in the rolling piston and vane, for restraining a rotary motion of the rolling piston.

2. The apparatus of claim 1, wherein the fixing units include a fixing groove formed at an outer circumferential surface of the rolling piston, and a contact fixing portion of the vane inserted into the fixing groove of the rolling piston.

3. The apparatus of claim 2, wherein the fixing groove is formed in a direction of length of the rolling piston.

4. The apparatus of claim 2, wherein the sectional surface of the fixing groove has a hemi-circular shape.

5. The apparatus of claim 2, wherein the contact fixing portion of the vane has a curved shape.

6. The apparatus of claim 1, wherein the fixing units include a protrusion portion protruded from an outer circumferential surface of the rolling piston, and an insertion groove formed at one end of the vane to allow the protrusion portion of the rolling piston to be inserted thereinto.

7. The apparatus of claim 6, wherein the protrusion portion of the rolling piston is formed in a direction of length of the rolling piston, and an outer surface of the protrusion portion has a curved shape.

8. The apparatus of claim 6, wherein the sectional surface of the insertion groove of the vane has a hemi-circular shape.

9. A rolling piston comprising:
a cylindrical body portion formed in a ring shape with predetermined length and thickness and rotatably coupled to the eccentric portion of the rotating shaft; and
a fixing groove formed at the outer circumferential surface of the cylindrical body portion in a direction of length thereof and into which one side of the vane is inserted.
